(19) United States
(12) Patent Application Publication
(10) Pub. No.: US 2019/0275663 A1
(43) Pub. Date: Sep. 12, 2019

(54) PORTABLE FOLDING SAW TABLE

(71) Applicant: Rafael Hernandez, Orlando, FL (US)

(72) Inventor: Rafael Hernandez, Orlando, FL (US)

(21) Appl. No.: 15/917,130

(22) Filed: Mar. 9, 2018

(51) Int. Cl. B25H 1/04; B23D 47/02

(52) U.S. Cl. CPC B25H 1/04; B23D 45/062; B23D 47/025

(57) ABSTRACT

A portable folding saw table includes a generally planar worksurface having a pair of folding legs that transition between an open orientation and a folded orientation. A generally rectangular indentation is located on the bottom end of the table and an elongated slit extends from the bottom end to the top end. A pair of brackets are arranged on each side of the indentation and engage a circular saw in an inverted position with the saw blade extending through the slit.

### TECHNICAL FIELD

The present invention relates generally to power saws, and more particularly to a portable table for use with a power saw.

### BACKGROUND

The statements in this section merely provide background information related to the present disclosure and may not constitute prior art.

It is common in the construction industry for workers to bring and utilize their own tools at a worksite. This is especially true for skilled workers such as carpenters, for example, who utilize many different types of power tools depending on the particular project or task at hand. For example, carpenters routinely use several different power saws such as circular saws, jigsaws, and/or reciprocating saws, for example.

Although these portable saws are useful in their own right, the undisputed workhorse of carpentry is the table saw. This is because table saws are capable of performing multiple tasks such as cutting sheets of plywood, making mitered cuts, and ripping boards to narrower widths. Unfortunately, this usability comes with a significant downside. Table saws are large heavy devices that are not easy to transport and/or setup. These limitations often prevent their usage on smaller jobs, where the time and effort to transport and setup the saw is weighed against the time and effort of using more portable and less accurate saws. Moreover, because table saws are expensive, many workers cannot afford to purchase one. As a result, newer carpenters and/or handyman workers are not routinely able to enjoy the benefits of such a device, and instead rely on a circular saw.

Accordingly, it would be beneficial to provide a lightweight portable folding saw table that can be utilized with a circular saw to provide a user with the full functionality of a traditional table saw without suffering from the drawbacks described above.

### SUMMARY OF THE INVENTION

The present invention is directed to a portable folding saw table. One embodiment of the present invention can include a generally planar worksurface having a pair of folding legs that transition between an open orientation and a folded orientation. A generally rectangular indentation is located on the bottom end of the table and an elongated slit extends from the bottom end to the top end.

In one embodiment, a pair of brackets are arranged on each side of the indentation and function to receive a circular saw in an inverted position with the saw blade extending through the slit.

A table saw is also provided which includes the above described table and a circular saw that is removably secured to the table.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view the saw table that is useful for understanding the inventive concepts disclosed herein.

FIG. 2A is a side view of the saw table in the open orientation, in accordance with one embodiment of the invention.

FIG. 2B is a side view of the saw table in the folded orientation, in accordance with one embodiment of the invention.

FIG. 3 is a perspective bottom view of the saw table, in accordance with one embodiment of the invention.

FIG. 4 is a perspective bottom view of the saw table in operation, in accordance with one embodiment of the invention.

FIG. 5 is a front view of the saw table in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described throughout this document, the term “complementary shape,” and “complementary dimension,” shall be used to describe a shape and size of a component that is identical to, or substantially identical to the shape and size of another identified component.

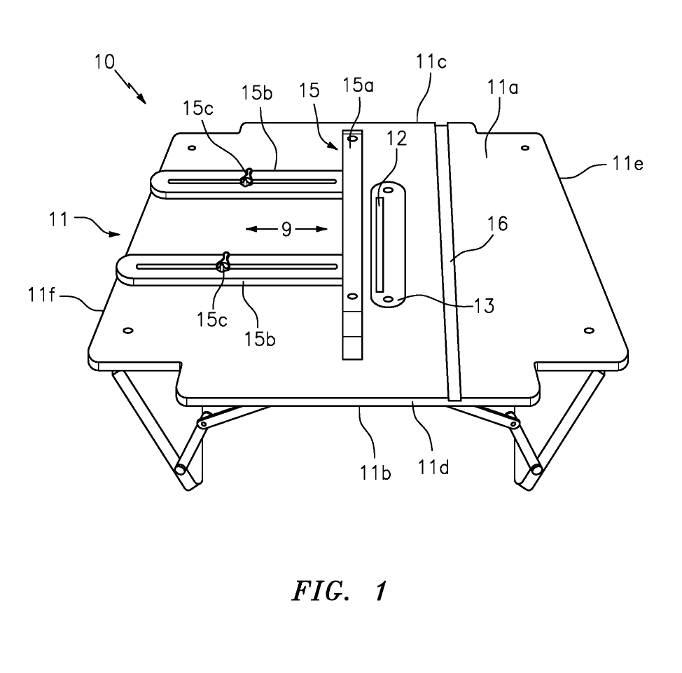

FIGS. 1-5 illustrate one embodiment of a portable folding saw table 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIG. 1, the table 10 can include a worksurface 11 having a flat top end 11a, a generally flat bottom end 11b, a front edge 11c, a rear edge 11d and a pair of opposing side edges 11e and 11f. The worksurface 11 can be constructed from any number of rigid materials such as wood, metal, or plastic, for example; however, any number of other materials are also contemplated.

An elongated slit 12 can extend from the bottom end 11b to the top end 11a. In one embodiment, the slit can be positioned at the center of the worksurface and can be oriented parallel with the side edges 11e and 11f. The slit 12 includes a shape and size that is suitable for allowing any number of different circular saw blades (typically between 4.5 to 7.25 inches) to pass therethrough and will preferably be surrounded by a metallic cutting guard 13.

A rip fence 15 can be slidingly connected to the top end 11a of the table 10. In one embodiment, the rip fence can include a raised guide 15a having a pair of transverse grooved supports 15b. The supports can engage hardware 15c, such as bolts and wingnuts, for example, that secured the rip guide to the top end 11a in a manner that allows the guide to be selectively moved toward and away from the slit 12, as shown by arrow a.

Although described above as utilizing a particular structure with guides and hardware, this is for illustrative purposes only. To this end, the rip fence can include any number of different components for providing a raised guide that can be selectively positioned in a parallel orientation to the slit 12. Additionally, any number of elongated slots, such as the illustrated miter slot 16 can be provided along the worksurface 11 to facilitate usage of components such as a featherboard, for example. Additionally, other embodiments also contemplate a blade guard (not illustrated) which can be hingedly secured along the top end 11a so as to encompass the slit 12 and the below described saw blade 5b during device operation.

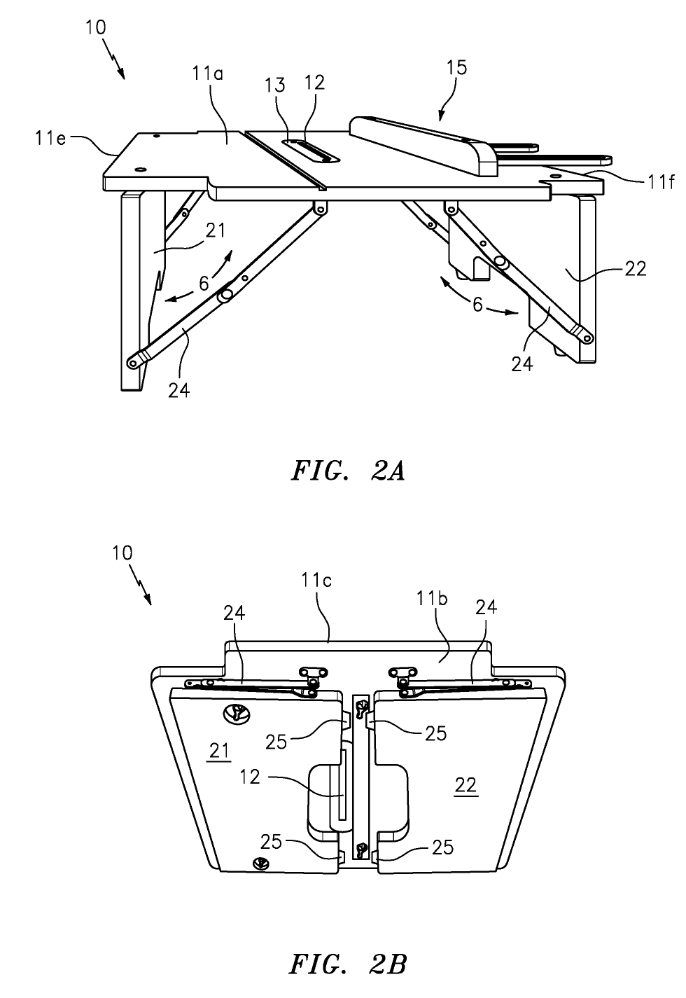

As shown in FIGS. 2A and 2B, the table 10 can include a pair of folding legs 21 and 22, that can be positioned beneath sides 11e and 11f of the worksurface, respectively. Each of the legs will preferably include a height that is approximately ½ the width of the worksurface, so as to transition (see arrow b) between the open orientation of FIG. 2A and the flat orientation shown in FIG. 2B. Such a feature is particularly important, as available space within work vehicles is often at a premium. Therefore, by providing a table which can fold flat and within itself maximizes the available space.

In the preferred embodiment, legs 21 and 22 can be secured to the bottom end of the worksurface 11b via hinges 23 and can further include folding supports 24 that are secured to each side of the legs. Additionally, a plurality of adjustable leg leveling glides 25 can be secured along the bottom ends of the legs to prevent movement/slippage of the table 10 during use, and to allow a user to ensure a perfectly level working surface.

Although described above as including two folding leg segments, this is for illustrative purposes only. To this end, other embodiments are contemplated wherein the leg segments are fixedly secured to the worksurface and/or wherein four distinct leg segments are individually secured to the worksurface in either a fixed or folding orientation. Additional embodiments are contemplated wherein each of the folding leg segments are telescopic in nature, so as to include an adjustable height when in the open orientation.

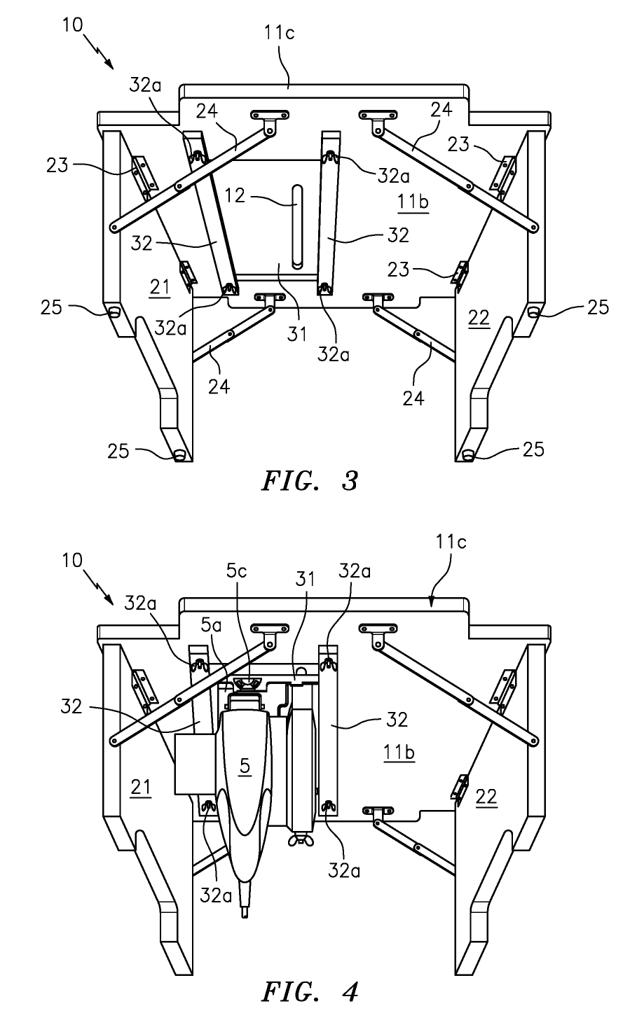

As shown in FIG. 3, the bottom end 11b of the table 10 can include a generally rectangular indentation 31 with the slit 12 is arranged longitudinally along one side. A pair of elongated brackets 32 can be positioned parallel to the slit 12 along the outer edges of the indentation. Each of the brackets can be removably secured to the bottom end of the worksurface 11b via hardware 32a such as bolts and wingnuts, for example, however other devices capable of securing the brackets to the table 10 in a removable manner are also contemplated.

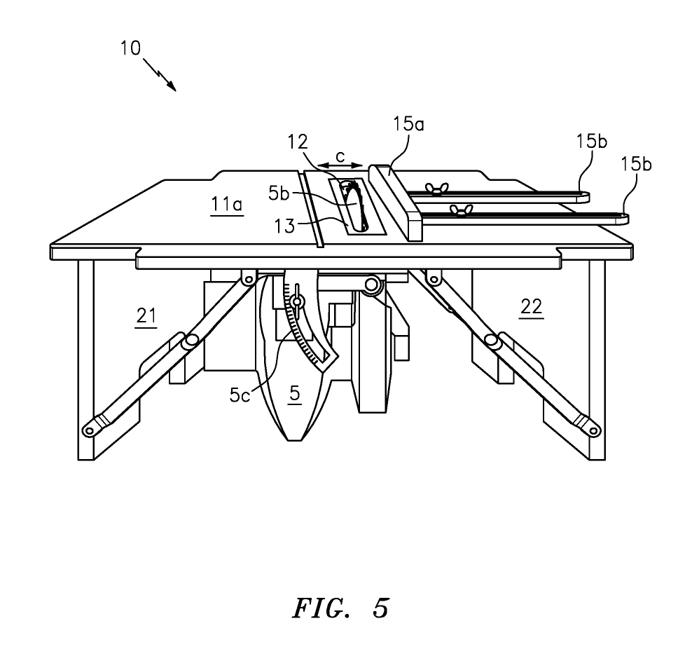

As shown in FIGS. 4 and 5, the indentation 31 can include a shape and size that is complementary to the shape and size of a base plate 5a of a circular saw 5. Additionally, the indentation can be oriented so as to position the saw blade 5b of the circular saw 5 through the slit 12, so as to extend up from the top end of the worksurface 11a. Next, the brackets 32 can be secured along each side of the saw base plate 5a and the table can be rotated to the upright position shown in FIG. 5.

Because only the base plate 5a is directly secured to the table, the plate tilt adjustment 5c of the saw is able to be fully utilized to angle (see arrow c) the portion of the saw blade 5b located above the top worksurface 11a. Such a feature provides users with the ability to easily make angled cuts during device operation. Moreover, because the power and control surfaces of the saw remain untouched, none of the saw's integrated safety mechanisms are affected by the table.

As noted above, it is important that the table 10 include as small a footprint as possible while providing all of the functionality described herein. To this end, the table can preferably include a worksurface depth (e.g., distance between sides 11c and 11d) of approximately 20 inches, a width (e.g., distance between sides 11e and 11f) of approximately 21 inches, and a height (e.g., distance between bottom ends of legs to the top ends of the legs) of approximately 10 inches. Such dimensions being suitable for allowing a circular saw 5 to be positioned in an inverted state beneath the worksurface when the table 10 is in the open orientation, and for allowing the legs to fold flat when the saw is removed and the table 10 is in the folded orientation. Of course, any number of other dimensions are also contemplated.

As described herein, one or more elements of the portable folding saw table 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A portable folding saw table, comprising:
a generally planar worksurface having a flat top end, a flat bottom end, a front end, a back end and a pair of opposing sides;
a pair of legs that are disposed beneath the opposing sides, said legs being hingedly secured to the bottom end of the worksurface and transition between an open orientation and a folded orientation; and
an elongated slit that extends between the top end and the bottom end of the worksurface, said slit including a shape and size that is suitable for receiving a circular saw blade.

2. The table of claim 1, further comprising:
a rip fence that is slidingly positioned onto the top end of the worksurface, said rip fence including a raised straight member that is oriented parallel with the elongated slit.

3. The table of claim 1, further comprising:
a rectangular indentation that is positioned along the bottom end of the worksurface, said indentation including a shape and size that is complementary to a shape and a size of a circular saw base plate.

4. The table of claim 3, further comprising:
a pair of elongated brackets that are secured to the bottom end of the worksurface, said brackets being located along an outer periphery of the indentation and at a parallel orientation to the elongated slit.

5. The table of claim 4, wherein the pair of elongated brackets are removably secured to the bottom end of the table and include a shape and size that are suitable for engaging the saw base plate of a circular saw positioned within the indentation.

6. The table of claim 1, wherein in the open orientation the bottom end of the worksurface includes a height that is greater than a height of a circular saw.

7. The table of claim 1, wherein in the folded position, the legs are positioned at a parallel orientation to the worksurface.

8. The table of claim 1, further comprising: an elongated miter slot that is disposed along the top end of the worksurface.

9. The table of claim 1, further comprising:
a plurality of folding supports that are connected between the bottom end of the worksurface and the pair of folding legs.

10. A table saw, comprising:
a generally planar worksurface having a flat top end, a flat bottom end, a front end, a back end and a pair of opposing sides;
a pair of legs that are disposed beneath the opposing sides, said legs being hingedly secured to the bottom end of the worksurface and transition between an open orientation and a folded orientation;
an elongated slit that extends between the top end and the bottom end of the worksurface;
a rectangular indentation that is positioned along the bottom end of the worksurface;
a circular saw that is removably positioned within the indentation, said circular saw including a saw blade that is positioned within the elongated slit and a saw base plate; and
a pair of elongated brackets are removably secured to the bottom end of the table, each of the brackets extending across a portion of the saw base plate and function to removably secure the circular saw to the bottom end of the table in an inverted position.

11. The table saw of claim 10, further comprising:
a rip fence that is slidingly positioned onto the top end of the worksurface, said rip fence including a raised straight member that is oriented parallel with the elongated slit.

12. The table of claim 10, further comprising: an elongated miter slot that is disposed along the top end of the worksurface.

13. The table of claim 10, further comprising:
a plurality of folding supports that are connected between the bottom end of the worksurface and the pair of folding legs.
